(19) United States
(12) Patent Application Publication
(10) Pub. No.: US 2005/0272457 A1
(43) Pub. Date: Dec. 8, 2005

(54) Handling transmissions via a radio link

(75) Inventors: Robert Nichols, Hampshire (GB); Arne Kumm, Hampshire (GB); Kanji Kerai, London (GB)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/862,780

(22) Filed: Jun. 7, 2004

(51) Int. Cl. H04B 7/00; H04B 17/00

(52) U.S. Cl. 455/522; 455/69; 455/67.11; 455/127.1

(57) ABSTRACT

The invention relates to a method of handling in a first electronic device transmissions to a second electronic device via a radio link. The first device supports for a radio link a first power mode using a transmission power within a first power range and a second power mode using a transmission power within a second power range. During a use of the first power mode, a value of at least one parameter is monitored. In case the monitored value of the at least one parameter lies within a predetermined value range associated to the second power mode, a switch from the first power mode to the second power mode is then caused. The invention relates equally to a module for a corresponding device, to a corresponding device, to a system comprising a corresponding device and to a corresponding software program product.

### FIELD OF THE INVENTION

The invention relates to a method of handling in a first electronic device transmissions to a second electronic device via a radio link. The invention relates equally to such an electronic device, to a radio link module for such an electronic device, to a system comprising such an electronic device and to a software program product storing a software for use in such an electronic device.

### BACKGROUND OF THE INVENTION

Radio links can be employed for connecting electronic devices to each other without requiring connections by cords.

Short-range radio links between electronic devices which are located close to each other have been specified for example in the “Specification of the Bluetooth system”, Version 1.1, Feb. 22, 2001. The specification is aimed at providing a standard for packet based low-complexity low-cost wireless connections between portable and/or fixed devices. An example for the employment of such a Bluetooth™ short-range radio link would be a wireless connection between a laptop or a mobile phone and a printer.

The Bluetooth™ specification defines several power modes for the output power. A Class 1 power mode is defined for a maximum output power of 100 mW, or 20 dBm. The minimum output power for this Class 1 power mode is 1 mW, or 0 dBm. A Class 2 power mode is defined for a maximum output power of 2.5 mW, or 4 dBm. The minimum output power for this Class 2 power mode is 0.25 mW, or −6 dBm. For the Class 1 power mode, a power control is mandatory. The power control is based on Received Signal Strength Indicator (RSSI) measurements at a receiving device, which reports back whether the power of the transmitting device should be increased or decreased. Only Class 1 devices are required to be able to provide RSSI measurements and related messages to another device.

Due to the higher maximum output power, the Class 1 power mode enables a considerably larger coverage area for Bluetooth™ links of a particular device than the Class 2 power mode. A Class 2 power mode enables only a link between devices which are within a range of about 10 m from each other. Various applications rely on the presence of a larger coverage area.

Standard single-chip Bluetooth™ enabled devices comprise an ASIC with an integrated power amplifier supporting the Class 2 power mode. This integrated power amplifier has a relatively small power consumption. When a Bluetooth™ enabled device is to be able to use the Class 1 power mode, however, it has to use in an external power amplifier, which consumes a large amount of current.

If the Bluetooth™ enabled device is a mobile electronic device, a large current by the Class 1 power amplifier results in a short battery life of the device. As a consequence, there are few mobile Bluetooth™ enabled devices, like Bluetooth™enabled mobile phones, which support the Class 1 power mode. This prevents the usage of various applications in mobile Bluetooth™ enabled devices.

### SUMMARY OF THE INVENTION

It is now invented a method, a module, a device, a system and a software program product to support a reduction of the power consumption in an electronic device which is adapted to use a high transmission power for a radio link to another electronic device, for example in a Bluetooth™ enabled device which is able to use a Class 1 power mode.

A method of handling in a first electronic device transmissions to a second electronic device via a radio link is proposed. The first electronic device supports for the radio link a first power mode using a transmission power within a first power range and a second power mode using a transmission power within a second power range. The proposed method comprises during a use of the first power mode monitoring a value of at least one parameter. The proposed method further comprises switching from the first power mode to the second power mode, in case the monitored value of the at least one parameter lies within a predetermined value range associated to the second power mode.

Moreover, a radio link module for a first electronic device is proposed. The radio link module is adapted to support a radio link between the first electronic device and a second electronic device. The radio link module comprises first power mode components adapted to employ for transmissions via a radio link to the second electronic device a first power mode using a transmission power within a first power range. The radio link module further comprises second power mode components adapted to employ for transmissions via a radio link to the second electronic device a second power mode using a transmission power within a second power range. The radio link module further comprises at least one switching element arranged to perform a switch between the first power mode components and the second power mode components. The radio link module further comprises a control component, which control component is adapted to monitor a value of at least one parameter while the first power mode is employed for transmissions via a radio link between the first electronic device and the second electronic device. The control component is further adapted to cause the at least one switching element to switch from the first power mode components to the second power mode components, in case the monitored value of the at least one parameter lies within a predetermined value range associated to the second power mode.

Such a radio link module can be for example, even though not exclusively, a Bluetooth™ module for a mobile terminal.

It has to be understood that the first power mode components and the second power mode components may comprise common components.

Moreover, an electronic device is proposed which comprises the features of the proposed radio link module.

Such an electronic device can be for example, even though not exclusively, a Bluetooth™ enabled mobile terminal.

Moreover, a system is proposed, which comprises the proposed electronic device and at least one further electronic device, wherein these device are adapted to be connected to each other via a radio link.

Finally, a software program product is proposed, in which a software code for handling in a first electronic device transmissions to a second electronic device via a radio link is stored. The first electronic device supports for the radio link a first power mode using a transmission power within a first power range and a second power mode using a transmission power within a second power range. When running in a processing component of the first electronic device, the software code realizes during a use of the first power mode a step of monitoring a value of at least one parameter. Further, the software code realizes a step of causing a switch from the first power mode to the second power mode, in case the monitored value of the at least one parameter lies within a predetermined value range associated to the second power mode.

The invention proceeds from the consideration that the output power required for a reliable transmission on a radio link depends on the respective situation. For example, a higher output power is required for a radio link between two electronic devices which are located at a large distance to each other or between which there are signal attenuating obstructions. A lower output power is required for saving power in a transmitting device. The invention proceeds further from the consideration that different situations can be reflected by the value of a selected parameter. It is therefore proposed to monitor such a value, and to switch during a radio link from a first power mode to a second power mode, if the second power mode is required or enabled given the current situation, which is indicated by the monitored parameter value.

The invention allows switching to a more advantageous power mode in a particular situation. As it is thus not necessary to employ a power mode using a higher power range during the entire existence of a particular radio link, the invention allows saving power in an electronic device. The invention is of particular advantage for mobile electronic devices, since saving battery power results in a longer use-time before the battery has to be recharged and in a longer battery life.

The first power range and/or the second power range may define at least one limit for power values. Alternatively, the first power range and/or the second power range may comprise as well only a single power value.

In one embodiment of the invention, a switching is enabled in both directions between the power modes. Thus, while the second power mode is used for transmissions, a value of at least one parameter is equally monitored. In case the monitored value of the at least one parameter lies within a predetermined value range associated to the first power mode, a switch is performed from the second power mode to the first power mode.

It has to be noted that the same parameter or different parameters can be monitored as a criteria for both switching directions. Moreover, one or more parameters could be monitored for each switching direction. It has further to be noted that in case the same parameter is monitored for both switching directions, the value range associated to the first power mode and the value range associated to the second power mode may, but do not have to be adjacent to each other. In case the value ranges are directly adjacent to each other, both value ranges may be defined by a single threshold value separating the value ranges. In case the value ranges are not directly adjacent to each other, a repeated switching is prevented while the electronic devices are in an instable situation in which the parameter value varies rapidly in a range between both value ranges.

In one embodiment of the invention, the first power mode uses a transmission power within a higher power range, while the second power mode uses a transmission power within a lower power range. The parameter values within the predetermined value range which are associated to the second power mode are then indicative, for example, of a higher signal strength than values outside of this predetermined value range.

In another embodiment of the invention, the first power mode uses a transmission power within a lower power range, while the second power mode uses a transmission power within a higher power range. The parameter values within the predetermined value range associated to the second power mode are then indicative, for example, of a lower signal strength than values outside of this predetermined value range.

The radio link can be for instance a radio link as defined in the Bluetooth™ specification, but equally any other type of radio link which is established between at least two electronic devices. If the radio link is a Bluetooth™ radio link, a power mode using a higher power range could be a Bluetooth™ Class 1 power mode, while a power mode using a lower power range could be a Bluetooth™ Class 2 power mode.

The monitored parameter or parameters can be selected arbitrarily. The monitored parameter or parameters can be related in particular, though not exclusively, to the signal strength of signals received at the first electronic device from the second electronic device via the radio link and/or to the distance between the first device and the second device. If several parameters are monitored, separate value ranges might be defined for each parameter.

Class 1 electronic devices which are compliant with the Bluetooth™ specification, for example, perform RSSI measurements, that is, measurements on the strength of received signals. These RSSI measurements could provide in a Bluetooth™ implementation one parameter value which is monitored.

In addition, further criteria might be taken into account for deciding whether a switch between the power modes is to be performed. Such further criterion might relate for instance to the capabilities of the involved devices, that is, to the features from a certain feature set which they support. Another criterion might relate to the services which are requested by the application for which the radio link is to be used, that is, to the connection set up. Yet another criterion might be related to the hardware used by the devices, that is, to the hardware support. Such further criteria might define for instance an additional condition which has to be met for a respective switching, or it might for instance influence the value ranges for the monitored parameter values.

For example, if a service making use of a radio link requires a high quality, a value range which is associated to a power mode using higher transmission powers might be larger, than if a service making use of a radio link requires a lower quality. Further, a particularly high required quality might be a criterion to prevent completely a switching from a power mode using higher transmission powers to a power mode using lower transmission powers.

The monitored parameters and the considered criteria can be evaluated for instance by an algorithm.

In one embodiment of the invention, the radio link is used for transmitting data packets between the first electronic device and the second electronic device, subsequent data packets being spaced apart at least by a predetermined interval. The switching between the power modes can then be performed exactly during an interval between two subsequent data packets. A switch between a Bluetooth™ Class 1 power mode and a Bluetooth™ Class 2 power mode, for example, can be performed dynamically during a connection, since there are always 180 μs available between subsequent packets which are to be transmitted.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of a system according to a first embodiment of the invention;

FIG. 2 is a flow chart illustrating a switching between a first power mode and a second power mode in the system of FIG. 1; and

FIG. 3 is a schematic block diagram of a system according to a second embodiment of the invention.

### DETAILED DESCRIPTION OF THE INVENTION

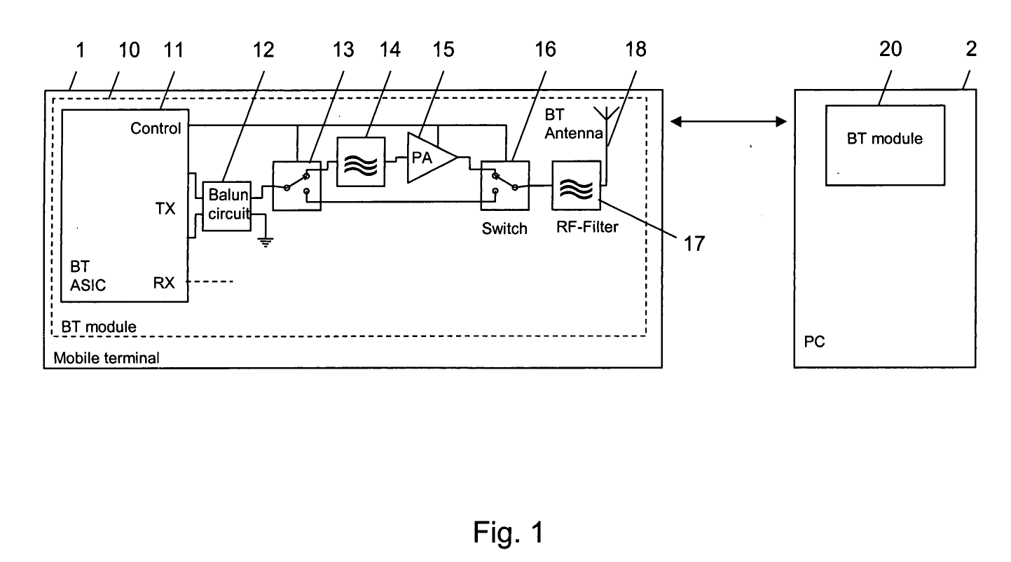

FIG. 1 schematically presents a system according to an embodiment of the invention, which enables a power reduction in a Bluetooth™ (BT) enabled device.

The system comprises a mobile terminal 1 as a first electronic device and a personal computer PC 2 as a second electronic device.

The mobile terminal 1 and the PC 2 both include a Bluetooth™ module 10, 20 as a respective radio link module.

The Bluetooth™ module 10 of the mobile terminal 1 comprises a Bluetooth™ ASIC 11. The ASIC 11 corresponds to a conventional Class 2 Bluetooth™ ASIC, except for a particular control portion.

A transmitter portion of the ASIC 11 comprises an integrated power amplifier supporting the Class 2 power mode. The transmitter portion TX of the ASIC 11 is connected outside of the ASIC 11 but within the Bluetooth™ module 10 via a Balun circuit 12, a first by-pass switch 13, a first RF filter 14, a power amplifier 15, a second by-pass switch 16 and a second RF filter 17 to a Bluetooth™ antenna 18. The first switch 13 is connected in addition directly to the second switch 16. This connection forms an alternative signal path.

The control portion of the ASIC 11 has a controlling access to the first switch 13, to the second switch 16 and to the power amplifier 15.

A receiver portion RX of the ASIC 11 is equally connected within the Bluetooth™ module 10 via several components to the Bluetooth™ antenna 18. This connection is not shown in FIG. 1, though.

Details of the Bluetooth™ module 20 of the PC 2 are not shown either in FIG. 1, since this module 20 may correspond to a conventional Class 1 Bluetooth™ module.

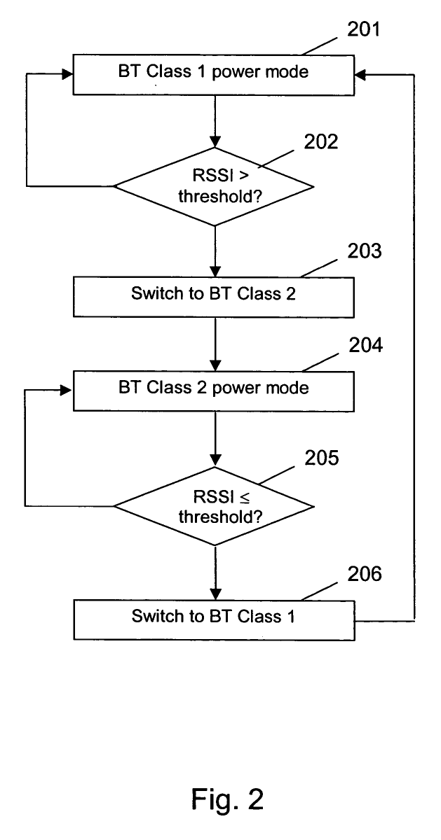

A power mode selection which enables a reduction of the power consumption in the mobile terminal 1 will now be explained with reference to the flow chart of FIG. 2.

The PC 2 can use for transmissions on a radio link to another Bluetooth™ enabled device either a Class 1 power mode or a Class 2 power mode, depending on the capabilities of the respective device to which the radio link is established.

In the system of FIG. 1, a radio link is to be established between the mobile terminal 1 and the PC 2.

As the mobile terminal 1 supports a Class 1 power mode, the radio link is established such that both devices 1, 2 use at first a Class 1 power mode. (step 201)

In the mobile terminal 1, this means that the control portion of the ASIC 11 causes the first switch 13 and the second switch 16 to connect the Balun circuit 12 via the first RF filter 14 and the power amplifier 15 to the second RF filter 17. The Bluetooth™ signals, which are to be transmitted to the PC 2, are output by the transmitter portion of the ASIC 11 without amplification by the integrated power amplifier. The Balun circuit 12 converts the differential RF signals output by the ASIC 11 into single ended signals, which are required for the antenna connection. Next, the single ended signals are filtered by the first RF filter 14. Then, the filtered signals are power amplified by the Class 1 power amplifier 15 in accordance with a control signal by the control portion of the ASIC 11. The control portion of the ASIC 11 sets the amplification factor of the power amplifier 15 within the limits of the Class 1 power range and depending on commands by the Bluetooth™ module 20 of the PC 2 received by the receiver portion of the ASIC 11. The amplified signals are further filtered by the second RF filter 17 and then provided for transmission to the antenna 18.

For each packet which is received from the PC 2 via the antenna 18, the receiver portion of the ASIC 11 performs RSSI measurements in accordance with the Bluetooth™ specification. The Bluetooth™ module 10 of the mobile terminal 1 orders the Bluetooth module 20 of the PC 2 to increase or decrease the output power depending on the RSSI measurements in a conventional manner.

In addition, the control portion of the ASIC 11 monitors the RSSI values resulting in the RSSI measurements which are performed by the receiver portion of the ASIC 11. (step 202)

In case an RSSI value does not exceed a predetermined threshold value, the Class 1 power mode is maintained by the mobile terminal 1. (step 201) As the RSSI values are inversely related to the distance between the mobile terminal 1 and the PC 2 and to the impact of obstructions between the terminal 1 and the PC 2, the Class 1 power mode is thus maintained as long as there is a relatively large distance between the mobile terminal 1 and the PC 2, for instance a distance of about 50 m, or as long as there are considerable obstructions between the terminal 1 and the PC 2.

In case the control portion detects that an RSSI value exceeds a predetermined threshold value, in contrast, the mobile terminal 1 switches to the Class 2 power mode. (step 203) To this end, the control portion of the ASIC 11 causes the first switch 13 and the second switch 16 to connect the Balun circuit 12 directly to the second RF filter 17. The switch is performed during an interval between two packets transmitted via the radio link, the packets being spaced apart by 180 μs.

Moreover, the control portion causes the transmitter portion of the ASIC 11 to amplify the Bluetooth™ signals by means of the internal Class 2 power amplifier. The amplification factor of the Class 2 power amplifier can be fixed or be set equally depending on commands by the PC 2. The amplified signals are output by the transmitter portion of the ASIC 11 and processed by the Balun circuit 12 for obtaining single ended signals. Thereafter, the signals are filtered by the second RF filter 17 and then provided for transmission to the antenna 18. (step 204)

The receiver portion of the ASIC 11 continues to perform RSSI measurements on each received packet and the control portion of the ASIC 11 continues to monitor the resulting RSSI values. (step 205)

As long as an RSSI value does not become equal to the predetermined threshold value or fall below this threshold value, the Class 2 power mode is maintained by the mobile terminal 1. (step 204) The Class 2 power mode is thus maintained as long as there is a relatively small distance between the mobile terminal 1 and the PC 2, for instance a distance of about 10 m, and no considerable obstructions. In case the control portion detects that an RSSI value becomes equal to the predetermined threshold value or falls below this threshold value, in contrast, the mobile terminal 1 switches back to the Class 1 power mode. (step 206) To this end, the control portion of the ASIC 11 causes the first switch 13 and the second switch 16 to connect the Balun circuit 12 again via the first RF filter 14 and the power amplifier 15 to the second RF filter 17. The switch is performed during an interval between two packets transmitted via the radio link.

The Class 1 power mode is then used again as described above with reference to step 201.

All components used in the Class 1 power mode form the first power mode components of the invention, while all components used in the Class 2 power mode form the second power mode components of the invention, or reversed.

On the whole, it becomes apparent that the presented system comprises a mobile terminal 1 which is able to dynamically switch between a Class 1 power mode and a Class 2 power mode depending on the strength of signals received via a Bluetooth™ link. Compared to a continuous use of a Class 1 power mode, this dynamic switching reduces the power consumption of the mobile terminal 1 whenever the established Bluetooth™ link can be maintained using the Class 2 power mode. Nevertheless, a Class 1 power mode is enabled for those applications for which a connection over a large distance might be required or for those situations in which there are obstructions between the mobile terminal 1 and another device to which the Bluetooth™ link is established. Consequently, the usability of a mobile terminal 1 is increased.

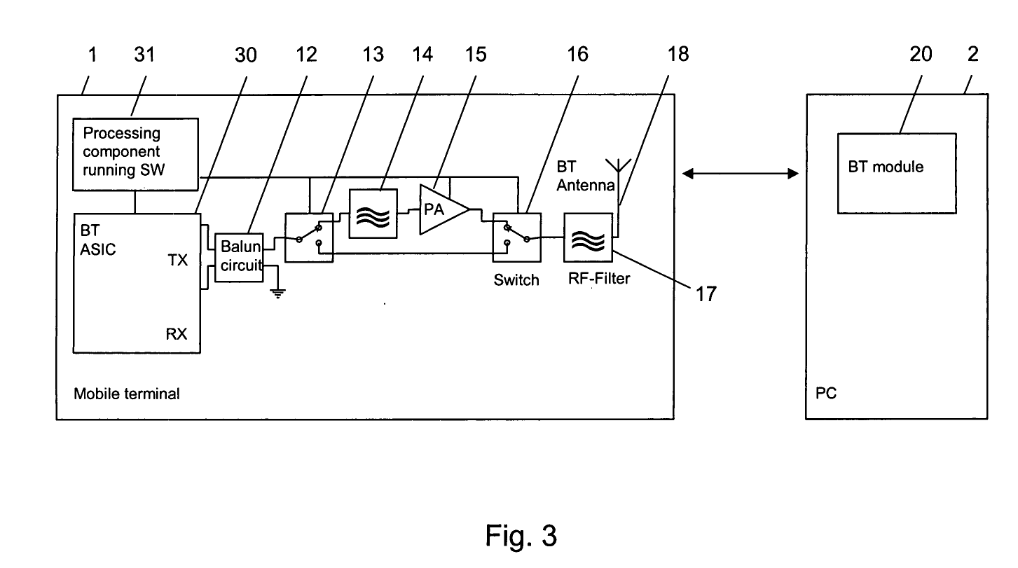

It has to be noted that the control of the switches 13, 16 does not necessarily have to be realized by a modified Class 2 Bluetooth™ ASIC 11. FIG. 3 schematically presents a second embodiment of a system according to the invention. The system of FIG. 3 is similar to the system of FIG. 1, and the same reference signs were used for corresponding components. The only difference is that in addition to a conventional Class 2 Bluetooth™ ASIC 30, a processing component 31 is employed. The processing component 31 has access to the ASIC 30, to the switches 13, 16 and to the power amplifier 15. The ASIC 30 provides measured RSSI values and possibly power control commands received from the PC 2 to the processing component 31. The processing component 31 runs a software SW, which is adapted to compare received RSSI values with a predetermined threshold value and to control the switches 13, 16 depending on the comparison, as described with reference to FIG. 2. The software SW might further be adapted to control the Class 1 power amplifier 16 in accordance with received power control commands, as described with reference to FIG. 2. The processing component 31 could be, for example, a part of a Bluetooth™ module comprising as well the other depicted components 12 to 18 and 30 or it could be, for example, a general processing component 31 of the mobile terminal 1 which is used as well for other functions.

While there have been shown and described and pointed out fundamental novel features of the invention as applied to some embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method of handling in a first electronic device transmissions to a second electronic device via a radio link, wherein said first electronic device supports for said radio link a first power mode using a transmission power within a first power range and a second power mode using a transmission power within a second power range, said method comprising during a use of said first power mode:
monitoring a value of at least one parameter; and
in case said monitored value of said at least one parameter lies within a predetermined value range associated to said second power mode, switching from said first power mode to said second power mode.

2. The method according to claim 1, wherein said value of said at least one parameter, monitored during a use of said first power mode, is related to at least one of a strength of signals received at said first electronic device via said radio link from said second electronic device and a distance between said first electronic device and said second electronic device.

3. The method according to claim 1, wherein at least one further criterion is taken into account for deciding on said switching from said first power mode to said second power mode.

4. The method according to claim 3, wherein said at least one further criterion comprises at least one of:
capabilities of said first electronic device;
capabilities of said second electronic device;
a set-up of said radio link;
a hardware support at said first electronic device; and
a hardware support at said second electronic device.

5. The method according to claim 1, further comprising during a use of said second power mode:
monitoring a value of at least one parameter; and
in case said monitored value of said at least one parameter lies within a predetermined value range associated to said first power mode, switching from said second power mode to said first power mode.

6. The method according to claim 5, wherein said value of said at least one parameter, monitored during a use of said second power mode, is related to at least one of a strength of signals received at said first electronic device via said radio link from said second electronic device and a distance between said first electronic device and said second electronic device.

7. The method according to claim 5, wherein at least one further criterion is taken into account for deciding on said switching from said second power mode to said first power mode.

8. The method according to claim 7, wherein said at least one further criterion comprises at least one of:
capabilities of said first electronic device;
capabilities of said second electronic device;
a set-up of said radio link;
a hardware support at said first electronic device; and
a hardware support at said second electronic device.

9. The method according to claim 1, wherein said first power mode uses a transmission power within a higher power range, wherein said second power mode uses a transmission power within a lower power range, and wherein parameter values within said predetermined value range associated to said second power mode are indicative of a higher signal strength than parameter values outside of said predetermined value range associated to said second power mode.

10. The method according to claim 1, wherein said first power mode is a Bluetooth™ Class 1 power mode, and wherein said second power mode is a Bluetooth™ Class 2 power mode.

11. The method according to claim 1, wherein said first power mode uses a transmission power within a lower power range, wherein said second power mode uses a transmission power within a higher power range, and wherein parameter values within said predetermined value range associated to said second power mode are indicative of a lower signal strength than parameter values outside of said predetermined value range associated to said second power mode.

12. The method according to claim 1, wherein said first power mode is a Bluetooth™ Class 2 power mode, and wherein said second power mode is a Bluetooth™ Class 1 power mode.

13. The method according to claim 1, wherein said value of said at least one parameter comprises a received signal strength indicator value measured at said first electronic device.

14. The method according to claim 1, wherein said radio link is used for transmitting data packets between said first electronic device and said second electronic device, subsequent data packets being spaced apart at least by a predetermined interval, and wherein a switching between said power modes is performed during an interval between two subsequent data packets.

15. A radio link module for a first electronic device, which radio link module is adapted to support a radio link between said first electronic device and a second electronic device, said radio link module comprising:
first power mode components adapted to employ for transmissions via a radio link to said second electronic device a first power mode using a transmission power within a first power range;
second power mode components adapted to employ for transmissions via a radio link to said second electronic device a second power mode using a transmission power within a second power range;
at least one switching element arranged to perform a switch between said first power mode components and said second power mode components; and
a control component, which control component is adapted to monitor a value of at least one parameter while said first power mode components are employed for transmissions via a radio link between said first electronic device and said second electronic device, and which control component is adapted to cause said at least one switching element to switch from said first power mode components to said second power mode components, in case said monitored value of said at least one parameter lies within a predetermined value range associated to said second power mode.

16. The radio link module according to claim 15, wherein said value of said at least one parameter, monitored by said control component while said first power mode components are employed for transmissions via a radio link, is related to at least one of a strength of signals received at said first electronic device via said radio link from a second electronic device and a distance between said first electronic device and a second electronic device.

17. The radio link module according to claim 15, wherein said control component is further adapted to monitor a value of at least one parameter while said second power mode is employed for transmissions via a radio link between said first electronic device and said second electronic device, and wherein said control component is further adapted to cause said at least one switching element to switch from said second power mode components to said first power mode components, in case said monitored value of said at least one parameter lies within a predetermined value range associated to said first power mode.

18. The radio link module according to claim 17, wherein said value of said at least one parameter, monitored by said control component while said second power mode components are employed for transmissions via a radio link, is related at least one of to a strength of signals received at said first electronic device via said radio link from a second electronic device and a distance between said first electronic device and a second electronic device.

19. The radio link module according to claim 15, wherein for controlling said switching element, said control component is adapted to take into account at least one further criterion.

20. The radio link module according to claim 19, wherein said at least one further criterion comprises at least one of:
capabilities of said first electronic device;
capabilities of said second electronic device;
a set-up of said radio link;
a hardware support at said first electronic device; and
a hardware support at said second electronic device.

21. The radio link module according to claim 15, wherein said first power mode uses a transmission power within a higher power range, wherein said second power mode uses a transmission power within a lower power range, and wherein parameter values within said predetermined value range associated to said second power mode are indicative of a higher signal strength than parameter values outside of said predetermined value range associated to said second power mode.

22. The radio link module according to claim 15, wherein said first power mode is a Bluetooth™ Class 1 power mode, and wherein said second power mode is a Bluetooth™ Class 2 power mode.

23. The radio link module according to claim 15, wherein said first power mode uses a transmission power within a lower power range, wherein said second power mode uses a transmission power within a higher power range, and wherein parameter values within said predetermined value range associated to said second power mode are indicative of a lower signal strength than parameter values outside of said predetermined value range associated to said second power mode.

24. The radio link module according to claim 15, wherein said first power mode is a Bluetooth™ Class 2 power mode, and wherein said second power mode is a Bluetooth™ Class 1 power mode.

25. The radio link module according to claim 15, wherein said value of said at least one parameter comprises a received signal strength indicator value measured at said first electronic device.

26. The radio link module according to claim 15, wherein said radio link module is adapted to exchange data packets via said radio link, subsequent data packets being spaced apart at least by a predetermined interval, and wherein said control component is adapted to cause said at least one switching element to switch between said power modes during an interval between two subsequent data packets.

27. An electronic device which is adapted to support a radio link to a second electronic device, said electronic device comprising:
first power mode components adapted to employ for transmissions via a radio link to said second electronic device a first power mode using a transmission power within a first power range;
second power mode components adapted to employ for transmissions via a radio link to said second electronic device a second power mode using a transmission power within a second power range;
at least one switching element arranged to perform a switch between said first power mode components and said second power mode components; and
a control component, which control component is adapted to monitor a value of at least one parameter while said first power mode components are employed for transmissions via a radio link between said electronic device and said second electronic device, and which control component is adapted to cause said at least one switching element to switch from said first power mode components to said second power mode components, in case said monitored value of said at least one parameter lies within a predetermined value range associated to said second power mode.

28. A system comprising a first electronic device and a second electronic device, wherein said first electronic device and said second electronic device are adapted to be connected to each other by a radio link, said first electronic device including:
first power mode components adapted to employ for transmissions via a radio link to said second electronic device a first power mode using a transmission power within a first power range;
second power mode components adapted to employ for transmissions via a radio link to said second electronic device a second power mode using a transmission power within a second power range;
at least one switching element arranged to perform a switch between said first power mode components and said second power mode components; and
a control component, which control component is adapted to monitor a value of at least one parameter while said first power mode components are employed for transmissions via a radio link between said first electronic device and said second electronic device, and which control component is adapted to cause said at least one switching element to switch from said first power mode components to said second power mode components, in case said monitored value of said at least one parameter lies within a predetermined value range associated to said second power mode.

29. A software program product in which a software code for handling in a first electronic device transmissions to a second electronic device via a radio link is stored, wherein said first electronic device supports for said radio link a first power mode using a transmission power within a first power range and a second power mode using a transmission power within a second power range, said software code realizing during a use of said first power mode the following steps when running in a processing component of said first device:
monitoring a value of at least one parameter; and
in case said monitored value of said at least one parameter lies within a predetermined value range associated to said second power mode, causing a switch from said first power mode to said second power mode.
